(19) United States
(12) Patent Application Publication
(10) Pub. No.: US 2012/0209881 A1
(43) Pub. Date: Aug. 16, 2012

(54) METHODS, SYSTEMS AND SOFTWARE FOR SEARCHING ACRONYMS, PHRASES, AND WORD GROUPINGS IN ELECTRONIC DOCUMENTS

(76) Inventor: Bruce Eliot Ross, River Forest, IL (US)

(21) Appl. No.: 13/371,262

(22) Filed: Feb. 10, 2012

Related U.S. Application Data
(60) Provisional application No. 61/442,707, filed on Feb. 14, 2011.
(60) Provisional application No. 61/449,399, filed on Mar. 4, 2011.

(51) Int. Cl. G06F 17/30

(52) U.S. Cl. 707/776; 707/E17.141

(57) ABSTRACT

Methods, systems and software for searching electronic documents allow a user to enter a single or multiple letters of a word group, name, phrase, or the like, and see hits that include the data inputted. The search tool solves the problem of finding the full words and ultimately the meaning of an acronym when reading a web page, word processing document, or other electronic searchable material. The search tool also solves the problem of searching through a document for particular word groups, phrases, and names, and may be especially useful where the exact spelling is unknown. The search tool may allow consumers the ability to search based on one or more characters of each name or word independently of the remaining characters in the name, phrase or word search.

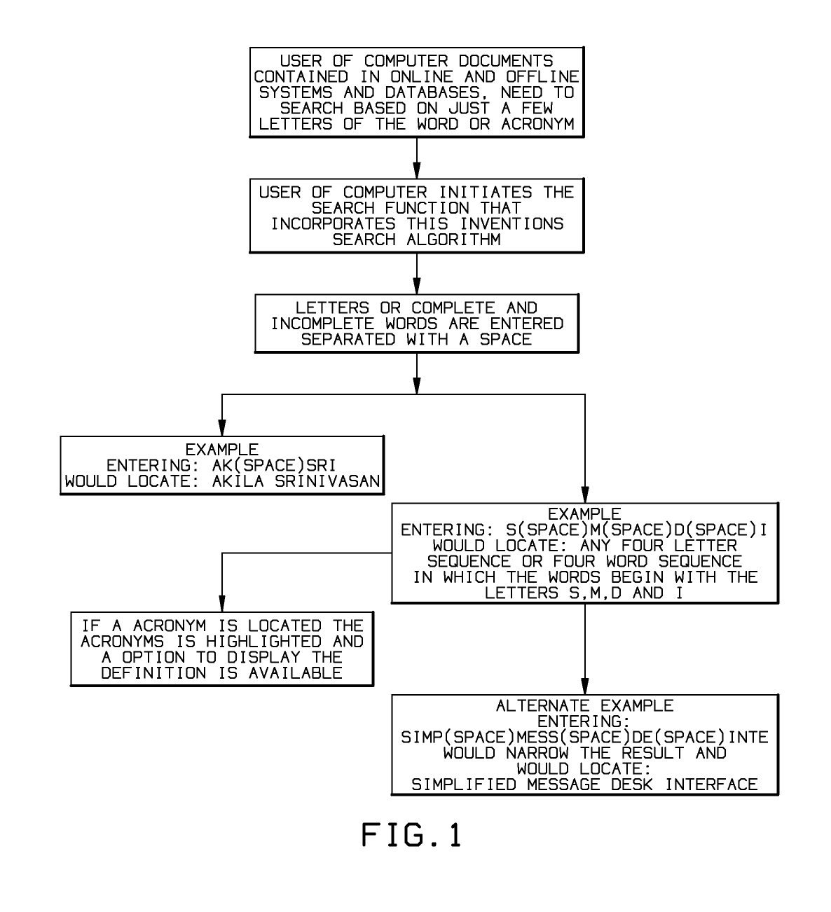

### CROSS-REFERENCE TO RELATED APPLICATIONS

This application claims the benefit of priority of U.S. provisional patent application No. 61/442,707, filed Feb. 14, 2011, and of U.S. provisional patent application No. 61/449,399, filed Mar. 4, 2011, the contents of which are herein incorporated by reference.

### BACKGROUND OF THE INVENTION

The present invention relates to electronic document searching and, more particularly, to methods, systems and software for searching for acronyms, phrases, word groupings, pairs or names using electronic documents, such as word processing documents, portable document format (pdf) documents, web pages, databases or the like.

When reading a web page, or other electronic document, it may be difficult to find the full words for acronyms. Moreover, it may be difficult to search through such an electronic document for specific words or phrases, especially when the exact spelling is not known.

Current search technology requires users to search using an entire word or phrase before a result will be presented. If a user does not know how to spell the phrase, words or name or the search submitted, it is ever more difficult to come up with the results one would expect.

For example, current search functions for searching web pages, word processing documents, pdf files or the like, requires a user to know the exact spelling of the name or phrase. Typically, for a phrase, a search is put in quotes to search for that exact phrase. If searching for a single word, however, many search tools allow a user to truncate a single word to find hits, however, a user cannot truncate multiple words in a phrase to find a given phrase.

As can be seen, there is a need for an improved search tool for electronic documents that may allow a user to search for word groups, phrases, acronyms, names and the like.

### SUMMARY OF THE INVENTION

In one aspect of the present invention, a method for searching an electronic document by a computerized system comprises obtaining a search selection from a user containing at least a first letter or group of letters, a search break character, and a second letter or group or letters; electronically searching a character searchable document for a word combination that includes the first letter or group of letters followed by the second letter or group of letters; and displaying the search results to a user, wherein the first letter or group of letters and the second letter or group of letters are only required to be characters in the word combination and are not required to be the exact word combination.

In another aspect of the present invention, a software having computer code disposed on a computer readable media, the computer code having computer code sequences adapted to carry out the steps of obtaining a search selection from a user containing at least a first letter or group of letters, a search break character, and a second letter or group or letters; electronically searching a character searchable document for a word combination that includes the first letter or group of letters followed by the second letter or group of letters; and displaying the search results to a user, wherein the first letter or group of letters and the second letter or group of letters are only required to be characters in the word combination and are not required to be the exact word combination.

These and other features, aspects and advantages of the present invention will become better understood with reference to the following drawings, description and claims.

### BRIEF DESCRIPTION OF THE DRAWINGS

The FIGURE is a flow chart showing exemplary searches according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides methods, systems and software for searching electronic documents allows a user to enter a single or multiple letters of a word group, name, phrase, or the like, and may output hits that include the data inputted. The present invention solves the problem of finding the full words and ultimately the meaning of an acronym when reading a web page, word processing document, or other electronically searchable material. The present invention also solves the problem of searching through a document for particular word groups, phrases, and names, and may be especially useful where the exact spelling is unknown. The search tool may allow consumers the ability to search based on one or more characters of each name or word independently of the remaining characters in the name, phrase or word search.

Referring to the FIGURE, a user of computer documents contained in online and offline systems and databases may need to know only one or more letters of a word or phrase. For example, a user may come across the acronym SMDI in a document. The user may be able to use the search tool of the present invention to type in “S”<space> “M”<space> “D”<space> “I” and the search tool will find all phrases that have these letters in sequence. For example, the search tool may output “Simplified Message Desk Interface”. Similarly, if the user entered “Simp”<space> “mess”<space> “d”<space> “inter”, the same result may be found. A “search break character” may be defined as a character inserted between the search terms in a search query. In the above example, the search break character is a <space>.

In some embodiments of the present invention, the search tool may be programmed to recognize small, non-searched words that may be situated in between the searched terms. For example, if “Simplified message for a desk interface” was in the document, the searches in the above paragraph may still find this result. The non-searched words may include, for example, articles such as “the”, “a”, and “an”, prepositions, such as “of”, “in”, “at”, and the like, and conjunctions, such as “and”, “or”, “for” and the like.

In some embodiments, for example, in a “name mode”, the search tool may be programmed to ignore one or two words that come in between terms. For example, if a user enters “Ak”<space> “Sri” into the search tool, the name “Akila Srinivasan” may be found. With the name option selected, if the name included a middle name or initial, the search tool may still output the same results. As can be seen, the search tool may be particularly useful when searching for a name when the spelling of the name may be uncertain.

In some embodiments of the present invention, if an acronym is located in the document, the acronym may be highlighted and an option may appear for the user to display its definition. For example, if the user searches for “S”<space> “M”<space> “D”<space> “I”, the search tool may provide an output of “simplified message desk interface” and may highlight the acronym where it appears in the document. Going forward, the user may be able to simply rest their mouse on the acronym to find the previously displayed definition. This may be helpful for readers and writers alike, as a reader may be able to see definitions of acronyms as they read a document, and a writer may type an acronym and make sure they have previously defined it, for example. In some embodiments, if the user types in an acronym and the search does not find a hit in the document, the software may call upon external resources, such as a cloud-based document or database, to find the meaning for the acronym. The search tool may also prompt the user to drop the selected found meaning into the first usage of the acronym in the current document.

The search tool of the present invention may take the form of software having various computer code sequences for carrying out the methods of the present invention. The software may be disposed on computer readable media, such as, but not limited to, a recordable optical or solid state storage medium, a computer memory, or the like.

In some embodiments, the search tool of the present invention may be a stand-alone tool, where a user may run the software and search a user supplied electronic document or file. In some embodiments, the search tool of the present invention may be a plug-in for or incorporated into an existing software, such as Microsoft Word, Adobe Acrobat, Google Docs, Internet Explorer, or the like. In this embodiment, a user may call on the software to perform a search and the search may be carried out with the methods of the present invention. For example, in Microsoft Word, a user currently may type control-F (or may locate and click on the appropriate menu item) to begin a search. When the present invention is added to the software, the search may be able to perform as described above, where the user may only need to type in certain letters or groups of letters from each word in a desired phrase.

It should be understood, of course, that the foregoing relates to exemplary embodiments of the invention and that modifications may be made without departing from the spirit and scope of the invention as set forth in the following claims.

What is claimed is:

1. A method for searching an electronic document by a computerized system, the method comprising:
obtaining a search selection from a user containing at least a first letter or group of letters, a search break character, and a second letter or group or letters;
electronically searching a character searchable document for a word combination that includes the first letter or group of letters followed by the second letter or group of letters; and
displaying the search results to a user, wherein
the first letter or group of letters and the second letter or group of letters are only required to be characters in the word combination and are not required to be the exact word combination.

2. The method of claim 1, wherein the first letter or group of letters and the second letter or group of letters are beginning characters of words in the word combination and are not required to be the exact word combination.

3. The method of claim 1, wherein the search break character is a space.

4. The method of claim 1, wherein the word combination excludes non-searched terms.

5. The method of claim 4, wherein the non-searched terms includes articles, conjunctions and prepositions.

6. The method of claim 1, wherein the electronic document is a word processing documents, a portable document format file, a web page or a database.

7. A software having computer code disposed on a computer readable media, the computer code having computer code sequences adapted to carry out the steps of:
obtaining a search selection from a user containing at least a first letter or group of letters, a search break character, and a second letter or group or letters;
electronically searching a character searchable document for a word combination that includes the first letter or group of letters followed by the second letter or group of letters; and
displaying the search results to a user, wherein
the first letter or group of letters and the second letter or group of letters are only required to be characters in the word combination and are not required to be the exact word combination.

8. The software of claim 7, wherein the software is integrated into an existing software product to provide search functionality thereto.

9. The software of claim 7, wherein the software is a stand-alone program adapted to search a user defined document or file.

10. The software of claim 7, wherein:
the first letter or group of letters and the second letter or group of letters are beginning characters of words in the word combination and are not required to be the exact word combination;
the search break character is a space; and
the word combination excludes non-searched terms.
